(19) United States
(12) Patent Application Publication
(10) Pub. No.: US 2025/0325897 A1
(43) Pub. Date: Oct. 23, 2025

(54) MULTI-CLAW GAME MACHINE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(21) Appl. No.: 18/777,391

(22) Filed: Jul. 18, 2024

(30) Foreign Application Priority Data
Apr. 22, 2024 (TW) 113114952

(51) Int. Cl. A63F 9/30; G07F 17/32

(52) U.S. Cl. CPC A63F 9/30; G07F 17/3297

(57) ABSTRACT

A multi-claw game machine includes a housing defining a game space, a plurality of action units, and a control unit signally connected to the action units and configured to control at least one of the action units. The action units are disposed in the game space and are spaced apart from each other, so that the game space is divided into a plurality of sub-areas that respectively correspond to the action units. Each action unit includes a bridge crane module disposed at a top of a respective one of the sub-areas, a claw mechanism connected to the bridge crane module, and a driving module connected to the bridge crane module. Each action unit has a specific parameter having a value different from the value of the specific parameter of at least another one of action units. A method is also provided for controlling the multi-claw game machine.

### CROSS-REFERENCE TO RELATED APPLICATION

This application claims priority to Taiwanese Invention Patent Application No. 113114952, filed on Apr. 22, 2024, the entire disclosure of which is incorporated by reference herein.

### FIELD

The disclosure relates to a game machine and a controlling method, and more particularly to a multi-claw game machine and a method for controlling the multi-claw game machine.

### BACKGROUND

Referring to FIG. 1, a conventional crane game machine 1 includes a housing 10 defining an inner space 100 for retaining a plurality of target articles (not shown), a claw mechanism 11 disposed in the inner space 100 for gripping the target articles, and an operation interface 12 connected to the housing 10 and operable to control the claw mechanism 11. In particular, because the inner space 100 allows a worker to freely place the target articles therein, the inner space 100 may be decorated with different gadgets and/or may accommodate various kinds of target articles to attract players to play. Accordingly, such game machines have become quite prevalent in recent years. In response to the various kinds of target articles, various models of the game machines have been developed.

However, regardless of how the crane game machines evolve, a standard game mode of such game machine, which controls only one claw at a time, may not be exciting enough for the players.

### SUMMARY

Therefore, an object of the disclosure is to provide a multi-claw game machine and a method for controlling the multi-claw game machine.

According to the disclosure, the multi-claw game machine includes a housing, a plurality of action units, and a control unit.

The housing defines a game space.

The action units are disposed in the game space and are spaced apart from each other in a transverse direction, so that the game space is divided into a plurality of sub-areas that respectively correspond to the action units. Each of the action units includes a bridge crane module that is disposed at a top of a respective one of the sub-areas, a claw mechanism that is connected to the bridge crane module, and a driving module that is connected to the bridge crane module and that is configured for controlling movement of the claw mechanism on the bridge crane module. Each of the action units has a specific parameter that has a value different from the value of the specific parameter of at least another one of the action units. The control unit is signally connected to the action units, and is configured to control at least one of the action units.

The method for controlling the multi-claw game machine includes a single-control mode that allows the control unit to operate a single one of the action unit at a time, and a multi-control mode that allows the control unit to operate at least two of the action units simultaneously.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a front view illustrating a conventional crane machine.

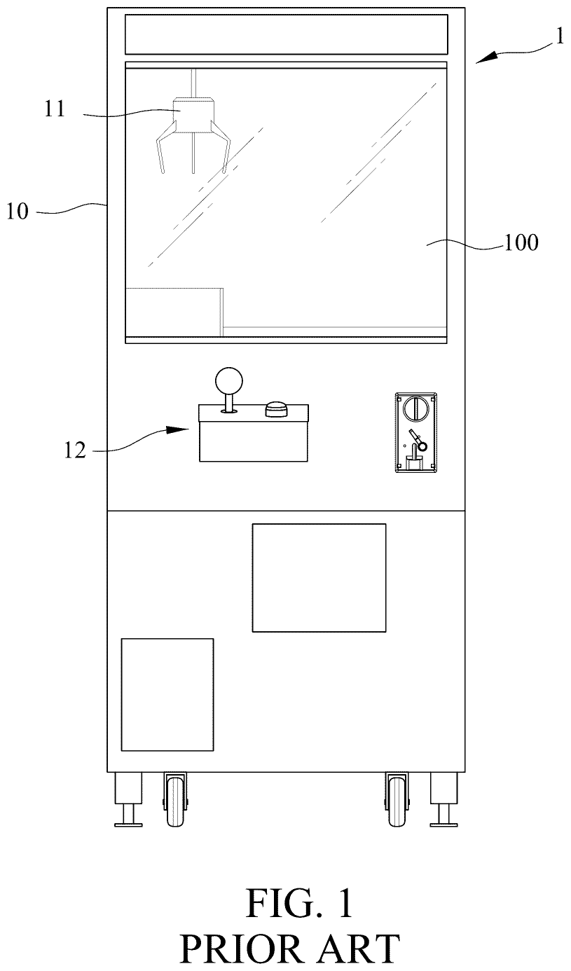

FIG. 2 is a front view illustrating a first embodiment of a multi-claw game machine according to the disclosure.

FIG. 3 is a fragmentary front view illustrating three action units of the first embodiment.

FIG. 4 is a schematic view illustrating that the action units are controlled by a control unit of the first embodiment.

FIG. 5 is a schematic top view illustrating a processing module of the control unit in a multi-control mode.

FIG. 6 is a schematic top view illustrating the processing module of the control unit in the multi-control mode.

FIG. 7 is front view illustrating a second embodiment of the multi-claw game machine according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

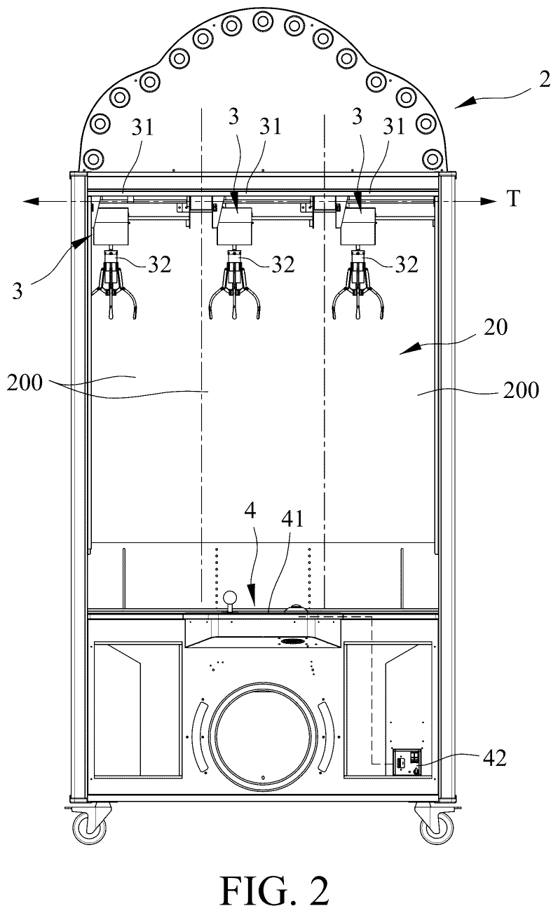

Referring to FIG. 2, a first embodiment of a multi-claw game machine according to the disclosure includes a housing 2 that defines a game space 20, three action units 3 that are disposed in the game space 20 and that are spaced apart from one another in a transverse direction (T), a control unit 4 that is signally connected to the action units 3 and that is configured to control at least one of the action units 3. The game space 20 may be freely placed with prizes (not shown) and be freely decorated by a worker. It should be noted that, although the multi-claw game machine including three action units 3 is described here, in practice, the number of the action unit 3 is not limited thereto.

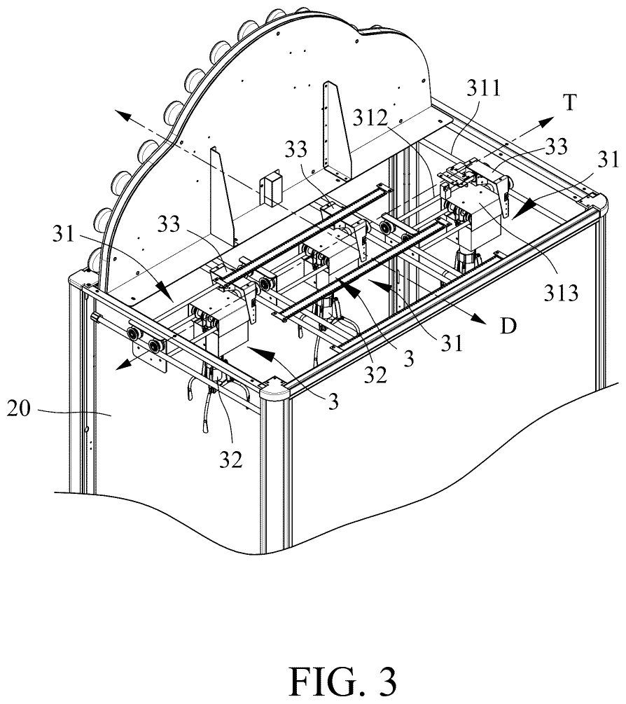

As shown in FIG. 2, through the action units 3, the game space 20 is divided into three sub-areas 200 that respectively correspond to the action units 3. Whether or not the sub-areas 200 are separated by physical partitions may depend on game design, arrangement in the game space 20, configuration of the multi-claw game machine, etc., and does not affect the operation of the disclosure. Referring to FIGS. 2 and 3, each of the action units 3 includes a bridge crane module 31 that is disposed at a top of a respective one of the sub-areas 200, a claw mechanism 32 that is connected to the bridge crane module 31, and a driving module 33 that is connected to the bridge crane module 31 and that is configured for controlling movement of the claw mechanism 32 on the bridge crane module 31. Specifically, with respect to each of the action units 3, the bridge crane module 31 includes a first slide rail 311 that extends in a front-rear direction (D) perpendicular to the transverse direction (T), a second slide rail 312 that is disposed on the first slide rail 311, that is movable relative to the first slide rail 11 in the front-rear direction (D), and that extends in the transverse direction (T), and a body portion 313 that is disposed on the second slide rail 312 and that is movable relative to the second slide rail 312 in the transverse direction (T). That is to say, the body portion 313 may move freely in the respective one of the sub-areas 200 in the transverse direction (T) and the front-rear direction (D). Specifically, with respect to each of the action unit 3, the claw mechanism 32 is connected to the body portion 313 of the bridge crane module 31, and the driving module 33 is configured for controlling the movement of the claw mechanism 32 by driving the body portion 313 of the bridge crane module 31.

The control unit 4 includes an operation interface 41 that is signally connected to the driving modules 33 of the action units 3, and a processing module 42 that is signally connected to the operation interface 41. In order to make the action units 3 different from one another in action, movement, etc., during operation, each of the action units 3 has a specific parameter that has a value different from the value of the specific parameter of at least another one of the action units 3. In the first embodiment, the specific parameter of each of action units 3 is an operating speed of the driving module 33 of the action unit 3. The processing module 42 is configured to control the value of the specific parameter of each of the action units 3. Specifically, the processing module 42 provides different power or different signal to the driving modules 33 so as to vary the values of the specific parameters (i.e., the operating speeds) of the driving modules 33.

Furthermore, the processing module 42 may be operated in one of a single-control mode that allows the operation interface 41 to operate a single one of the driving modules 33 at a time, and a multi-control mode that allows the operation interface 41 to operate at least two of the driving modules 33 simultaneously. In practice, when the processing module 42 is operated in the single-control mode, a selected one of the driving module 33 is operated by the operation interface 41 or the driving modules 33 are sequentially operated by the operation interface 41.

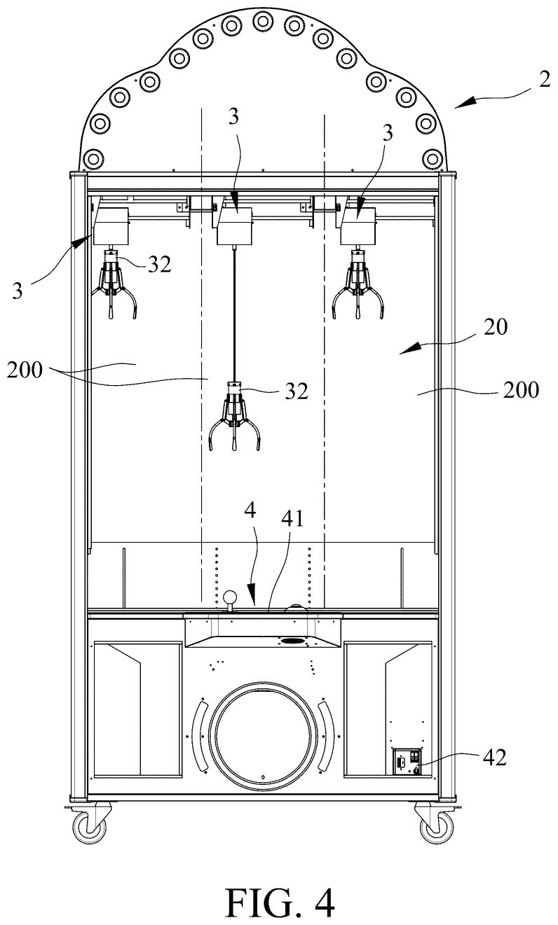

Referring to FIGS. 3 and 4, when the processing module 42 is operated in the single-control mode, a player may determine to operate a selected one of the driving module 33 or to sequentially operate the driving module 33 by inserting a specific number of coins, operating the operation interface 41, etc. Since the driving module 33 of each of the action units 3 operates according to the value of the specific parameter of the action unit 3, the player may notice a difference in moving speeds of the claw mechanisms 32 of the action units 3 when switching among the action units 3. Furthermore, the faster the claw mechanism 32 moves, the more difficult to get the prize, so that prizes with relatively high prices may be placed in the sub-areas 200 that correspond to the claw mechanisms 32 with relatively high moving speeds, thereby generating a diverse game experience.

Referring to FIGS. 2, 3 and 5, when the processing module 42 is operated in the multi-control mode, the at least two of the driving modules 33 are operated simultaneously, so that the corresponding at least two of the claw mechanisms 32 move simultaneously at different moving speeds. Operating multiple claw mechanisms 32 simultaneously at different moving speeds to get the prize is challenging for the player and therefore is a new way to play.

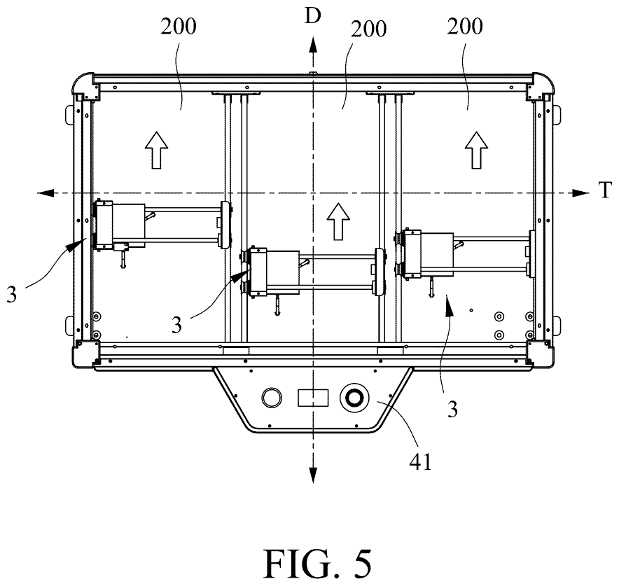

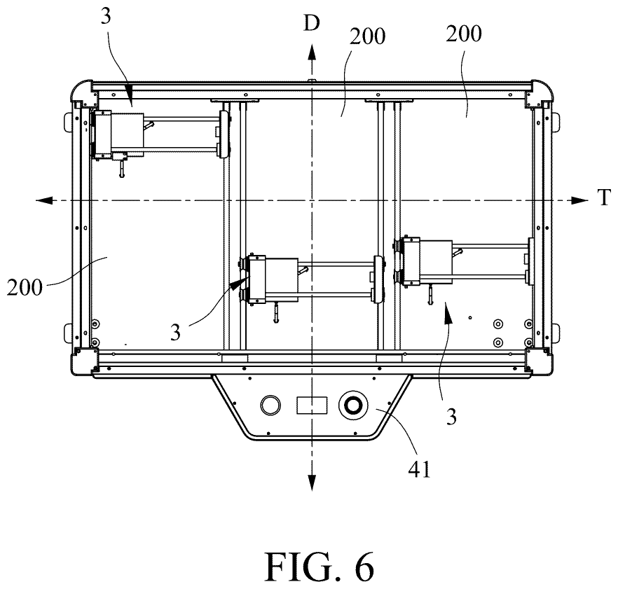

Referring to FIGS. 5 and 6, it should be noted that, since the action units 3 move at different moving speeds, while playing, one of the action units 3 may have reached a boundary of its movable range in the front-rear direction (D) while others of the action units 3 have not yet reached their movable ranges in the front-rear direction (D). For example, in a situation as illustrated in FIG. 6, one of the action units 3 is moved to the rearmost. In such situation, if the player continues to operate the action units 3 to move in the same direction (i.e., the player continues to operate the action units 3 to move rearwardly) when the one of the action units 3 has already reached the boundary of its movable range, the others of the action units 3 may keep moving or stop moving based on the game design.

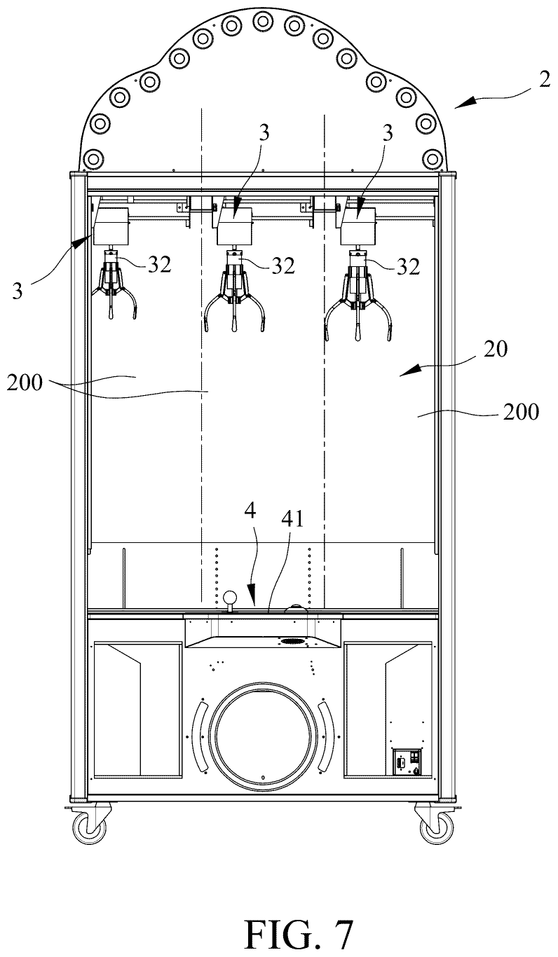

Referring to FIG. 7, a second embodiment of the multi-claw game machine according to the disclosure is illustrated. In the second embodiment, the specific parameter of each of the action units 3 is a weight of the claw mechanism 32 of the action unit 3. Specifically, a size of the claw mechanism 32 of each of the action units 3 is different from the size of the claw mechanism 32 of at least another one of the action units 3 according to prizes that are placed in the respective one of the sub-areas 200, so that weights of the claw mechanisms 32 of the action units 3 are different. Therefore, when driving forces from the driving module 33 of the action units 3 are the same, a moving speed of a heavier claw mechanism 32 is slower than a moving speed of a lighter claw mechanism 32. That is to say, as compared to the first embodiment, the second embodiment adopts a different manner to vary the moving speeds of the claw mechanisms 32.

In summary, according to the multi-claw game machine of the disclosure, the moving speeds of the claw mechanisms 32 may vary due to the specific parameters of the action units 3 so that the multi-claw game machine offers a diverse way to play compared to the conventional crane game machine. Thus, the object of the disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A multi-claw game machine, comprising:
a housing that defines a game space;
a plurality of action units that are disposed in said game space and that are spaced apart from each other in a transverse direction, so that said game space is divided into a plurality of sub-areas that respectively correspond to said action units, each of said action units including a bridge crane module that is disposed at a top of a respective one of said sub-areas, a claw mechanism that is connected to said bridge crane module, and a driving module that is connected to said bridge crane module and that is configured for controlling movement of said claw mechanism on said bridge crane module, each of said action units having a specific parameter that has a value different from the value of the specific parameter of at least another one of said action units; and
a control unit that is signally connected to said action units, and that is configured to control at least one of said action units.

2. The multi-claw game machine as claimed in claim 1, wherein said control unit includes an operation interface that is signally connected to said driving modules of said action units, and a processing module that is signally connected to said operation interface and that is configured to control the value of the specific parameter of each of said action units.

3. The multi-claw game machine as claimed in claim 2, wherein the specific parameter of each of said action units is an operating speed of said driving module of said action unit.

4. The multi-claw game machine as claimed in claim 1, wherein said control unit includes an operation interface that is signally connected to said driving modules of said action units, and a processing module that is signally connected to said operation interface, said processing module being able to be operated in one of a single-control mode that allows said operation interface to operate a single one of said driving modules at a time, and a multi-control mode that allows said operation interface to operate at least two of said driving modules simultaneously.

5. The multi-claw game machine as claimed in claim 4, wherein, when said processing module of said control unit is operated in the single-control mode, a selected one of said driving modules is operated by said operation interface.

6. The multi-claw game machine as claimed in claim 4, wherein, when said processing module is operated in the single-control mode, said driving modules are sequentially operated by said operation interface.

7. The multi-claw game machine as claimed in claim 1, wherein the specific parameter of each of said action units is a weight of said claw mechanism of said action unit.

8. The multi-claw game machine as claimed in claim 1, wherein said bridge crane module of each of said action units includes a first slide rail that extends in a front-rear direction perpendicular to the transverse direction, a second slide rail that is disposed on said first slide rail, that is movable relative to said first slide rail in the front-rear direction, and that extends in the transverse direction, and a body portion that is disposed on said second slide rail and that is movable relative to said second slide rail in the transverse direction.

9. A method for controlling a multi-claw game machine, performed on the multi-claw game machine, with said multi-claw game machine comprising a plurality of action units and a control unit, each of said action units including a claw mechanism and a driving module configured for controlling movement of said claw mechanism on said bridge crane module, each of said action units having a specific parameter that has a value different from the value of the specific parameter of at least another one of said action units, said control unit signally connected to said action units and configured to control at least one of said action units, said method comprising:
said control unit receives an operation and is operated in one of a single-control mode that allows said operation interface to operate a single one of said driving modules at a time, and a multi-control mode that allows said operation interface to operate at least two of said driving modules simultaneously.

10. The method for controlling the multi-claw game machine as claimed in claim 9, wherein said control unit includes an operation interface that is signally connected to said driving modules of said action units, and a processing module that is signally connected to said operation interface, and wherein the specific parameter is provided to each of said driving modules by said processing module.

11. The method for controlling the multi-claw game machine as claimed in claim 9, wherein the specific parameter of each of said action units is an operating speed of said driving module of said action unit.

12. The method for controlling the multi-claw game machine as claimed in claim 9, wherein when said control unit is operated in the single-control mode, a selected one of said driving modules is operated.

13. The method for controlling the multi-claw game machine as claimed in claim 9, wherein when said control unit is operated in the single-control mode, said driving modules are sequentially operated.

14. The method for controlling the multi-claw game machine as claimed in claim 9, wherein the specific parameter of each of said action units is a weight of said claw mechanism of said action unit.
